(19) United States
(12) Patent Application Publication
(10) Pub. No.: US 2012/0137440 A1
(43) Pub. Date: Jun. 7, 2012

(54) VACUUM CONTROL OF SEAT SECTION BLADDERS

(76) Inventor: Sandy M. RICHARDS, Pershing, IN (US)

(21) Appl. No.: 12/957,866

(22) Filed: Dec. 1, 2010

(51) Int. Cl. A61G 7/015; A61G 7/05; A47C 27/10; A61G 7/00

(52) U.S. Cl. 5/618; 5/713

(57) ABSTRACT

A patient support apparatus includes a mattress having a seat and a leg portion which are deflatable during movement of the patient support apparatus. The mattress includes a covering that is generally air impermeable so that a negative pressure can be developed inside of the covering.

### BACKGROUND

The present disclosure is related to patient support apparatuses including inflatable mattresses. More specifically, the present disclosure is related to a patient support apparatus having an inflatable mattress that varies in size during movement of the patient support apparatus to a chair egress position.

Patient support apparatuses, such as hospital beds, for example, may include deck sections that are expandable or retractable to vary the size of the deck section. For example, a patient support apparatus may include a deck section to support the lower legs with the foot deck section being extendable or retractable to act as a foot prop to support the foot of a patient on the patient support apparatus. In patient support apparatuses that move to a chair egress position, such as the Hill-Rom® TotalCare® bed, the foot deck section may retract to prevent interference with the floor when the foot deck section is lowered to a generally vertical position.

When a hospital bed moves to a chair egress position, the seat and leg portion of the mattress of the hospital bed may present interference during the egress process. In some instances, the seat bladders and leg bladders are deflated to assist with the patient egress. Materials formerly supported by the inflated bladders become loose and slip relative to the bladders.

### SUMMARY

The present application discloses one or more of the features recited in the appended claims and/or the following features which, alone or in any combination, may comprise patentable subject matter.

According to the present disclosure, a patient support apparatus comprises an air system and an inflatable support structure. The air system includes a source of pressurized air, a manifold coupled to the source of pressurized air and having a plurality of valves to change the path of air flow through the manifold, and a plurality of conduits. The inflatable support structure includes a first bladder for supporting a portion of a patient and a covering enclosing the bladder. The covering is generally air-tight. A first conduit is in fluid communication with the manifold and the first bladder. A second conduit is in fluid communication with the manifold such that the air system is operable to develop a negative pressure in the second conduit to evacuate the covering.

The covering may comprise urethane coated nylon.

The air system may be operable to vary the pressurized air in either conduit between a positive pressure and a negative pressure. In some embodiments, the air system is operable to simultaneously inflate the bladder and evacuate the covering.

In some embodiments, the inflatable support structure may further include a second bladder operable independently of the first bladder. The covering may also include a first enclosure enclosing the first bladder and a second enclosure, independent of the first enclosure, enclosing the second bladder.

When the covering includes the separate enclosures, the second conduit is in fluid communication with the first enclosure of the covering and a third conduit may be in fluid communication with the second enclosure. The first and second enclosures may be independently evacuated.

The air system may further include a fourth conduit coupled to the second bladder and the manifold. The first and second bladders may be inflatable to different pressures.

In some embodiments, the first bladder is positioned to support at least a portion of the buttocks of a patient lying in a supine position on the patient support apparatus. The second bladder may be positioned to support at least a portion of the legs of a patient lying in a supine position on the patient support apparatus.

The patient support apparatus may be movable between a horizontal bed position and a chair egress position, with the first bladder being inflated and the second bladder being deflated when the patient support apparatus is in the chair egress position. In other embodiments, both the first and second bladders may be deflated in the chair egress position.

The bladders and the covering may be simultaneously evacuated. Also, the covering may be evacuated while the bladder remains inflated to provide support to the portion of the patient supported on the bladder.

In some embodiments, the first and second bladders are substantially air-tight and the first and second enclosures are generally air-tight.

When the patient support apparatus is movable between a horizontal bed position and a chair egress position, the air supply may be operable to deflate the first and second bladders while evacuating the first and second enclosures while the patient support apparatus moves to the chair egress position. Also, the air supply may be operable to selectively deflate either the first or the second bladder or both bladders while selectively evacuating either of the first and second enclosures or both enclosures while the patient support apparatus moves to the chair egress position.

The patient support apparatus may further include a foot deck section having a variable length and movable to a generally vertical downward position. The second bladder may deflate and the second enclosure may be evacuated as the length of the foot deck section is reduced.

### BRIEF DESCRIPTION OF THE DRAWINGS

The detailed description particularly refers to the accompanying figures, in which:

FIG. 1 is a perspective view of a patient support apparatus including a foot deck section that is extendable and retractable, the patient support apparatus movable to a chair egress position;

FIG. 2 is a side view of a portion of the patient support apparatus of FIG. 1 with the foot deck section in a raised position;

FIG. 3 is view similar to FIG. 2 with the foot deck section lowered and retracted, the seat and leg portions of a mattress of the patient support apparatus collapsed;

FIG. 4 is a block diagram of a portion of a control system of the patient support apparatus of FIG. 1;

FIG. 5 is a block diagram of the air management system of the patient support apparatus;

FIG. 6 is a diagrammatic view of a cross-section of the mattress of the patient support apparatus of FIG. 1;

FIG. 7 is a view similar to FIG. 6 with a bladder partial deflated; and

FIG. 8 is a diagrammatic view of the cross-section shown in FIG. 6 with the portion of the mattress shown evacuated by the air management system of FIG. 5.

### DETAILED DESCRIPTION OF THE DRAWINGS

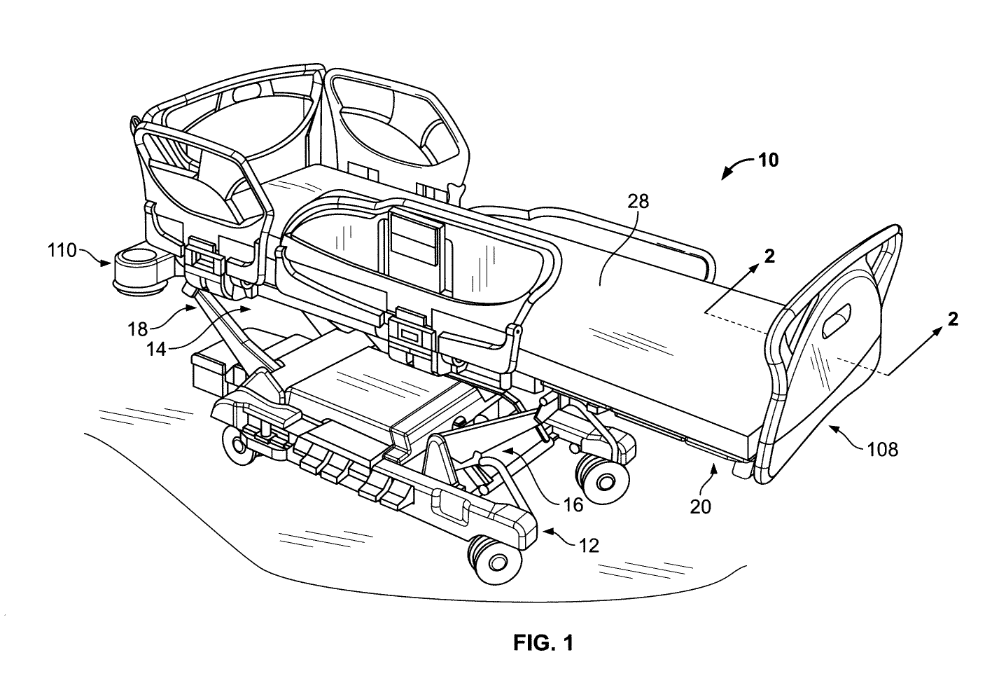

A patient support apparatus, illustratively embodied as a hospital bed 10 shown in FIG. 1, includes a lower frame 12 and an upper frame 14 movable relative to the lower frame 12. The upper frame 14 is supported on two pairs of lift arms 16 and 18, respectively. The lift arms 16 are positioned generally at a foot end 108 of the lower frame 12 and the lift arms 18 are positioned generally at a head end 110 of the lower frame 12. Reference to the foot end 108 and the head end 110 of the hospital bed 10 is intended to provide an orientation reference and does not refer to any specific surface or element of the hospital bed 10. The hospital bed 10 of FIG. 1 is movable from a horizontal bed position as shown in FIG. 1 to a chair egress position in which the foot deck section 20 of the hospital bed 10 is lowered to a generally vertical position as shown in FIG. 3. The patient supported on the hospital bed 10 may egress or exit the hospital bed 10 from the foot end 108 of the hospital bed 10 in a seated position.

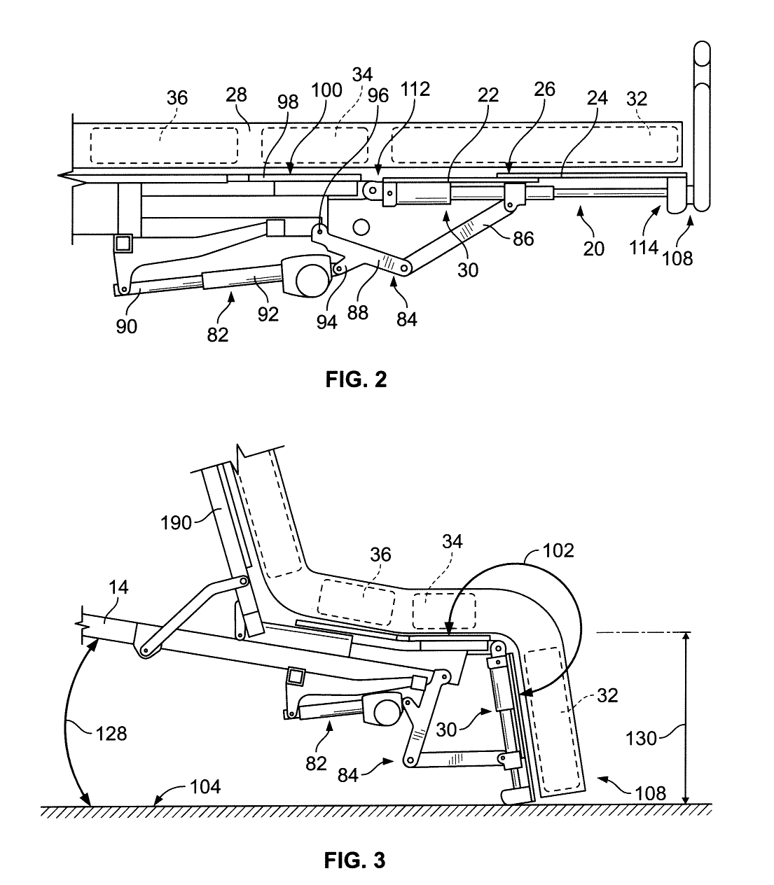

As shown in FIGS. 2-3, the foot deck section 20 of the hospital bed 10 includes a base 22 and an extender 24 movable relative to the base 22 to vary the length of the foot deck section 20. The foot deck section 20 defines a support surface 26 which supports at least a portion of a mattress 28. The support surface 26 is variable in size and increases in size as the extender 24 moves relative to the base 22 to increase the length of the foot deck section 20. The extender 24 is supported from the base 22 and movable relative to base 22 between a fully extended position as shown in FIG. 1 and a retracted position as shown in FIG. 3.

Referring now to FIG. 2, the foot deck section 20 changes in length when acted on by an actuator 30 that is connected at a first end 112 to the base 22 of the foot deck section 20. A second end 114 of the actuator 30 is connected to the extender 24. The actuator 30 extends and retracts the foot deck section 20 to vary the length of the foot deck section 20 and the size of the support surface 26.

Extension and retraction of the foot deck section 20 may be used to modify the length of the hospital bed 10 to accommodate patients of different heights, or may be used to retract the foot deck section 20 when the foot deck section 20 is moved to a generally vertical position as shown in FIG. 3. As shown in FIGS. 2-3, the foot deck section 20 is supported on the upper frame 14 and pivotal relative to the upper frame 14. A linear actuator 82 rotates a crank 84 which supports the foot deck section 20 through an arm 86 which is pivotally coupled to the foot deck section 20 and a link 88 of the crank 84. The linear actuator 82 includes a rod 90 which extends and retracts relative to a body 92, with the actuator 82 acting on a link 94 of the crank 84 which causes the crank to rotate about an axis 96. Operation of a linear actuator 82 causes the foot deck section 20 to move relative to a thigh deck section 98 such that a surface 100 of the thigh deck section 98 and the support surface 26 of the foot deck section 20 form a variable angle 102. The angle 102 between surface 26 and surface 100 is variable with a straight angle being formed between the surface 26 and 100 when the foot deck section 20 is in a position to support a patient in a supine position on the hospital bed 10. As shown in FIG. 3, the angle 102 may be as great as approximately 270° when the foot deck section 20 is lowered to position the hospital bed 10 in the chair egress position. In the chair egress position shown in FIG. 3, the foot deck section 20 is fully retracted to reduce the height 130 of the thigh deck section 98 from the floor 104 when the upper frame 14 is lowered to the chair egress position.

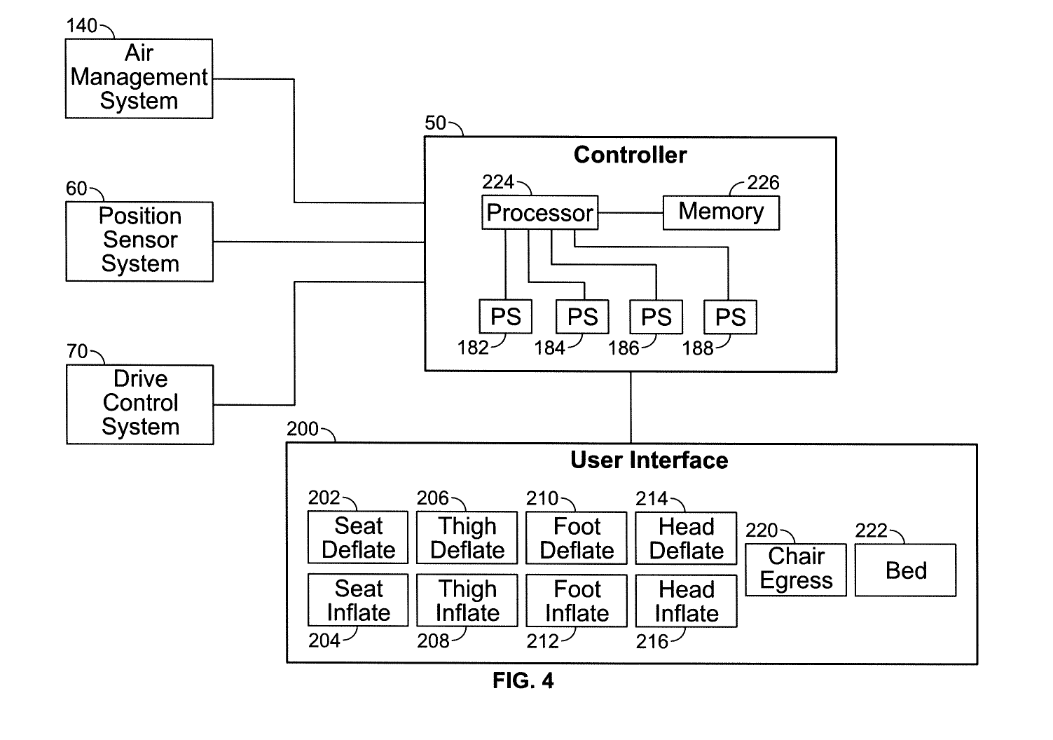

The upper frame 14 is tiltable relative to the floor 104 to increase form an angle 128 of about 187°. In this attitude, the thigh deck section 98 is positioned approximately horizontally as shown in FIG. 4 to form the chair egress position. With the foot deck section 20 fully retracted, the height 130 is reduced to provide a position for a patient to egress from the foot end 108 of the hospital bed 10.

The mattress 28 includes a foot section bladder 32, a thigh section bladder 34, a seat section bladder 36, and a head section bladder 38 as shown in FIG. 3. It should be noted that while the illustrative embodiment includes the bladders 32, 34, 36, and 38, other embodiments may have more or fewer bladders. In addition, in some embodiments, the bladders will be omitted and replaced with multiple chambers connected into a bladder assembly with each chamber in fluid communication with the other chambers in the assembly such that each chamber is inflated to the same pressure.

In the chair egress position shown in FIG. 3, the foot section bladder 32 is completely deflated and the thigh section bladder 34 is partially deflated. In some instances, the seat section bladder 36 may also be deflated when the hospital bed 10 is in the chair egress position. Deflation of the bladders 32, 34, and 36 assists in lowering the effective height of the surface the patient is seat upon and reduces the potential interference of mattress 28 and any associated lines with the egress of the patient.

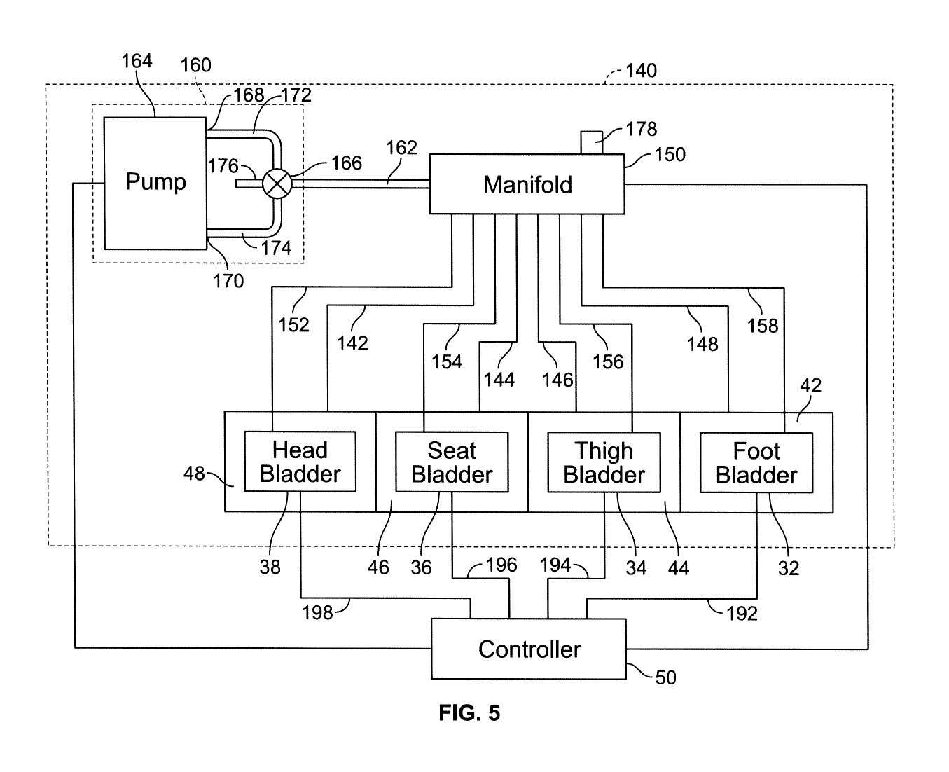

In the illustrative embodiment, the bladders 32, 34, 36 and 38 are each enclosed in a separate chamber as shown diagrammatically in FIG. 5. The foot bladder 32 is enclosed in a chamber 42, the thigh bladder 34 is enclosed in a chamber 44, the seat bladder 36 is enclosed in a chamber 46, and the head bladder 38 is enclosed in a chamber 48. Each of the chambers 42, 44, 46, and 48 are generally air tight but ambient air may be drawn into the chamber is a sufficient negative pressure is developed.

Each of the bladders 32, 34, 36 and 38 and chambers 42, 44, 46, and 48 are connected to a manifold 40. The bladders 32, 34, 36 and 38 are connected to the manifold 40 by respective conduits 52, 54, 56, and 58. The chambers 42, 44, 46, and 48 are connected to the manifold 40 by respective conduits 62, 64, 66, and 68. In addition, a number of conduits 72, 74, 76, and 78 are connected between the respective bladders 32, 34, 36 and 38 and pressure sensors 132, 134, 136, and 138. The pressure sensors 132, 134, 136, and 138 are part of a controller 50 that controls operation of a portion of the hospital bed 10. The controller 50 is also in communication with a position sensor system 60 and a drive control system 50. The controller 50 utilizes data from the position sensor system 60 and the pressure sensors 132, 134, 136, and 138 to control operation of the drive control system 50 and an air management system 140.

Referring now to FIG. 5, the air management system 140 under the direction of the controller 50, controls the pressure in the bladders 32, 34, 36, and 38 as well as the chambers 42, 44, 46, and 48 to coordinate the operation of the mattress 28 with the movement of the various portions of the hospital bed 10, including the movement of and length of the foot deck section 20. The air control system 140 includes a manifold 150 includes a number of valves (not shown) that are operated by the controller 50 and control the flow of air into and out of the bladders 32, 34, 36, and 38 as well as the chambers 42, 44, 46, and 48. In the illustrative embodiment, each bladder 32, 34, 36, and 38 is connected to the manifold 150 by a respective conduit 152, 154, 156, and 158. Similarly, each chamber 42, 44, 46, and 48 is connected to the manifold 150 by a conduit 142, 144, 146, and 148. A source of pressurized air 160 is connected to the manifold 150 by a conduit 162. The manifold 150 controls the flow path between the source of pressurized air 160 and the bladders 32, 34, 36, and 38 and chambers 42, 44, 46, and 48. The source of pressurized air 160 includes a pump 164 and a switching valve 166. The switching valve 166 is capable of changing the flow path of air through several variations. The pump 164 includes an inlet 168 and an outlet 170 each of which is connected to the valve 166 by a respective conduit 172 and 174. The switching valve 166 also includes a vent 176 open to atmosphere. The manifold 150 also includes a vent 178 independent of the switching valve 166.

When one or more of the bladders 32, 34, 36, and 38 is to be inflated, the switching valve 166 is positioned such that ambient air is drawn through the vent 176 into the inlet 168 of the pump 164, pressurized by the pump 164, and communicated to the manifold 150 through the outlet 170, conduit 174, valve 166 and conduit 162. The manifold 150 then distributes the pressurized air to the bladders 32, 34, 36, and 38 as required to obtain a target pressure in the bladders 32, 34, 36, and 38. The pressure in the bladders 32, 34, 36, and 38 is monitored by the controller 50 which includes pressure sensors 182, 184, 186, and 188 that are associated with the respective bladders 32, 34, 36, and 38. Each pressure sensor 182, 184, 186, and 88 is connected to the respective bladder 32, 34, 36, and 38 by a respective conduit 192, 194, 196, and 198 such that the sensor is in fluid communication with its respective bladder and can thereby sense the pressure in the bladder.

The controller 50 automatically controls the pressure in the various bladders 32, 34, 36, and 38 based on several factors as understood in the art. The controller 50 operates a drive control system 70 to control the operation of various drives on the hospital bed 10 and monitors the position of structures of the hospital bed 10 as detet mined by a position sensor system 60. For example, a user may choose to raise a head section 190 of the hospital bed 10. During movement of the head section 190, the controller 50 may adjust the pressure in one or more of the bladders 32, 34, 36, and 38 based on the amount of inclination of the head section 190.

In the illustrative embodiment, the hospital bed 10 includes a user interface 200 that has a number of user input devices that allow a user to control operation of the hospital bed 10. For example, a user input device 202 allows a user to signal the controller 50 to deflate the seat section bladder 34, while a user input device 204 provides signal indicative of the users desire to inflate the seat section bladder 34. User input devices 206 and 208 are associated with the deflation and inflation of the thigh section bladder 36, respectively. User input devices 210 and 212 provide respective signals of the user desire to deflate and inflate the foot section bladder 32. User input devices 214 and 216 are associated with the deflation and inflation of the head section bladder 38. The user interface 200 also includes a user input device 220 that provides a signal to the controller 50 that the user wishes to move the hospital bed 10 to the chair egress position. A user input device 222 provides a signal indicative of the users desire to move the hospital bed 10 to the horizontal bed position.

Under normal operating conditions, the pressure in the bladders 32, 34, 36, and 38 is controlled automatically by the controller 50. The controller 50 includes a processor 224 and a memory device 226. The memory device 226 includes instructions used by the processor 224 to operate the drive control system 70 and the air management system 140. For example, if a user actuates the user input device 220 to move the hospital bed 10 to the chair egress position, the controller 50 will monitor the position of various components of the hospital bed 10, raise the head section 190, lower and retract the foot deck section 20, and cause the upper frame 14 to move to the tilted position shown in FIG. 3. While the hospital bed 10 is being repositioned to the chair egress position, the controller 50 will cause the thigh section bladder 34 and foot section bladder 32 to deflate. The controller 50 may also cause the seat section bladder 36 to deflate as well.

Deflation of any of the bladders 32, 34, 36, and 38 may be accomplished by opening the respective bladder 32, 34, 36, and 38 to atmosphere through the vent 178 on the manifold 50. In some cases, the pressurized air source 160 may be used to draw a negative pressure in the bladder to evacuate the bladder. To cause the evacuation of the bladders 32, 34, 36, and 38 the switching valve 166 is moved to a position in which the conduit 162 from the manifold 150 to the switching valve 166 is connected to the inlet 168 of the pump 164 and the vent 176 of the switching valve 166 is in communication with the outlet 170 of the pump 164. In this position, the pump 166 pulls air from the bladders 32, 34, 36, and 38 and expels it to atmosphere. The manifold 150 selectively controls the flow path to draw air from the specific bladder(s) to be evacuated.

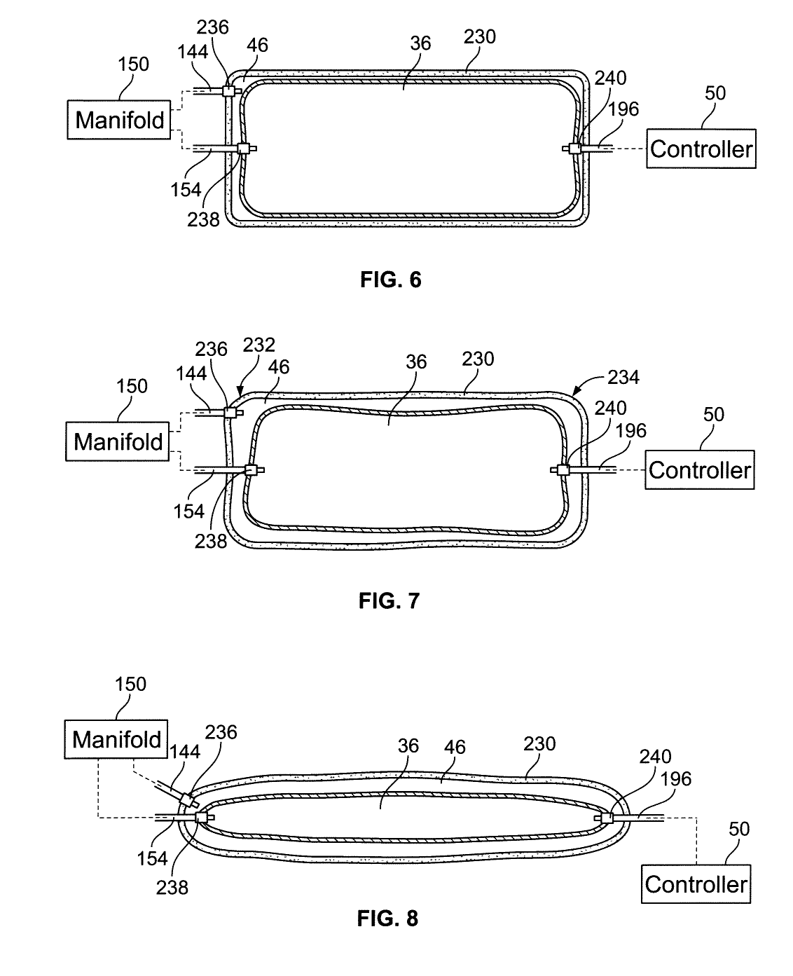

The bladders 32, 34, 36, and 38 of the mattress 28 are positioned inside of a ticking 230 that comprises a urethane coated nylon fabric. Referring now to FIGS. 6 and 7, the seat section bladder 36 is shown diagrammatically enclosed within the ticking 230. When the bladder 36 is inflated as shown in FIG. 6, the bladder 36 expands to substantially fill the chamber 46. As the bladder 36 is deflated or evacuated as shown in FIG. 7, the ticking 230 is loose relative to the bladder 36 as shown at points 232 and 234. The loose bladder 36 and ticking 230 permit movement of the ticking 230 relative to the bladder 36 and presenting the possibility for an occupant to slip to an improper position or to become partially entangled in the loose material during egress.

As shown in FIGS. 6-8, the chamber 46 is in fluid communication with the manifold 150 through the conduit 144 which is connected to the chamber by a fitting 236. Each of the bladders 32, 34, 36, and 38 and chambers 42, 44, 46, and 48 are connected to the manifold through fittings that connect the respective conduits to the bladders or chambers. For example, bladder 36 is connected to conduit 154 through a fitting 238. The conduits 192, 194, 196, and 198 that connect the respective pressure sensors 182, 184, 186, and 188 to the respective bladders 32, 34, 36, and 38 also connect to the bladders 32, 34, 36, and 38 through fittings. For example, as shown in FIGS. 6-8, conduit 196 is connected to the bladder 36 by a fitting 240.

The controller 50 is also operable to evacuate the chambers 42, 44, 46 and 48 under certain conditions. For example, when the seat bladder 36 is deflated, the controller 50 may cause the pressurized air source 160 to evacuate the chamber 46 to cause the ticking 230 to stay in close proximity to the bladder 36 and thereby reduce the potential for interference with the positioning or egress of the patient. Referring to FIG. 8, the bladder 36 and chamber 46 are shown having been evacuated to cause the mattress 28 to have a minimal height and the ticking 230 and bladder 36 to be tightly contained. In the illustrative embodiment, the chamber 46 is generally air tight, but the ticking may allow air to flow into the chamber 46 is a sufficient negative pressure is developed. In some embodiments, the chamber 46 may be substantially air tight so that a negative pressure is developed inside the chamber 46 to draw the material in very tightly. In some embodiments, the chamber 46 may include a check valve that opens to atmosphere if the pressure in the chamber 46 drops below a predetermined negative pressure so that the pressurized air source 160 will have a flow of ambient air.

In some embodiments, the chamber 46 may have a conduit that communicates the pressure in the chamber to a pressure sensor of the controller 50 so that the controller 50 may control the operation of the pressurized air source 160 to draw a specific negative pressure in the chamber 46.

While the forgoing discussion has addressed the chamber 46 and bladder 36, it should be understood that any of the other bladders 32, 34, and 38 and chambers 42, 44, and 48 may be configured and operate in a similar manner. In addition, the chambers 42, 44, 46, and 48 may be configured so that multiple bladders 32, 34, 36, and 38 are included in a single chamber.

Upon re-inflation of the bladder 36, the controller 50 may cause the chamber 46 to be opened to atmosphere by placing the conduit 144 in communication with the vent 178 of the manifold 50. For example, if a user were to actuate the user input device 222 to move the hospital bed 10 back to the horizontal bed position, the chamber 46 is opened to atmosphere and the bladder 36 is inflated to a support pressure.

In some cases, a user may wish to deflate a particular portion of the mattress 28 by selecting one of the user input devices 202, 206, 210, or 214. The controller 50 may cause the chamber 42, 44, 46, or 48 that encloses the bladder 32, 34, 36, and 38 being deflated by the user to be evacuated to control the position of the ticking 230.

Although certain illustrative embodiments have been described in detail above, variations and modifications exist within the scope and spirit of this disclosure as described and as defined in the following claims.

1. A patient support apparatus comprising
an air system including a source of pressurized air, a manifold coupled to the source of pressurized air and having a plurality of valves to change the path of air flow through the manifold, and a plurality of conduits, and
an inflatable support structure having a first bladder for supporting a portion of a patient and a covering enclosing the bladder, the covering being generally air-tight, wherein a first conduit is in fluid communication with the manifold and the first bladder and a second conduit in fluid communication with the manifold such that the air system is operable to develop a negative pressure in the second conduit to evacuate the covering.

2. The patient support apparatus of claim 1, wherein air system is operable to vary the pressurized air in either conduit between a positive pressure and a negative pressure.

3. The patient support apparatus of claim 1, wherein air system is operable to simultaneously inflate the bladder and evacuate the covering.

4. The patient support apparatus of claim 1, wherein the inflatable support structure includes a second bladder operable independently of the first bladder.

5. The patient support apparatus of claim 4, wherein the covering includes a first enclosure enclosing the first bladder and a second enclosure, independent of the first enclosure, enclosing the second bladder.

6. The patient support apparatus of claim 5, wherein the second conduit is in fluid communication with the first enclosure of the covering and further including a third conduit in fluid communication with the second enclosure.

7. The patient support apparatus of claim 6, wherein the first and second enclosures may be independently evacuated.

8. The patient support apparatus of claim 7, wherein the patient support apparatus further comprises a fourth conduit coupled to the second bladder and the manifold and wherein the first and second bladders are inflatable to different pressures.

9. The patient support apparatus of claim 8, wherein the covering comprises urethane coated nylon.

10. The patient support apparatus of claim 9, wherein the first bladder is positioned to support at least a portion of the buttocks of a patient lying in a supine position on the patient support apparatus and the second bladder is positioned to support at least a portion of the legs of a patient lying in a supine position on the patient support apparatus.

11. The patient support apparatus of claim 10, wherein the patient support apparatus is movable between a horizontal bed position and a chair egress position, with the first bladder being inflated and the second bladder being deflated when the patient support apparatus is in the chair egress position.

12. The patient support apparatus of claim 8, wherein the patient support apparatus is movable between a horizontal bed position and a chair egress position, with the first bladder being inflated and the second bladder being deflated when the patient support apparatus is in the chair egress position.

13. The patient support apparatus of claim 1, wherein the bladder and the covering may be simultaneously evacuated.

14. The patient support apparatus of claim 1, wherein the covering may be evacuated while the bladder remains inflated to provide support to the portion of the patient supported on the bladder.

15. The patient support apparatus of claim 1, wherein the patient support apparatus is movable between a horizontal bed position and a chair egress position, with the first bladder being inflated and the covering being evacuated when the patient support apparatus is in the chair egress position.

16. The patient support apparatus of claim 1, wherein the patient support apparatus is movable between a horizontal bed position and a chair egress position, with the first bladder being deflated and the enclosure being evacuated when the patient support apparatus is in the chair egress position.

17. The patient support apparatus of claim 1, wherein the inflatable support structure includes a second bladder operable independently of the first bladder and the covering includes a first enclosure enclosing the first bladder and a second enclosure, independent of the first enclosure, enclosing the second bladder, the first and second bladders being substantially air-tight and the first and second enclosure being generally air-tight.

18. The patient support apparatus of claim 17, wherein the patient support apparatus is movable between a horizontal bed position and a chair egress position and the air supply is operable to deflate the first and second bladders while evacuating the first and second enclosures while the patient support apparatus moves to the chair egress position.

19. The patient support apparatus of claim 17, wherein the patient support apparatus is movable between a horizontal bed position and a chair egress position and the air supply is operable to selectively deflate either the first or the second bladder or both of the bladders while selectively evacuating either of the first and second enclosures or both of the enclosures while the patient support apparatus moves to the chair egress position.

20. The patient support apparatus of claim 19, wherein the patient support apparatus includes a foot deck section having a variable length and movable to a generally vertical downward position the second bladder deflating and the second enclosure evacuating as the length of the foot deck section is reduced.
